(19) United States
(12) Patent Application Publication
(10) Pub. No.: US 2025/0157363 A1
(43) Pub. Date: May 15, 2025

(54) Temporary Road Sign Device

(71) Applicant: Ted Hudson, Muskegon, MI (US)

(72) Inventor: Ted Hudson, Muskegon, MI (US)

(21) Appl. No.: 18/389,562

(22) Filed: Nov. 14, 2023

(51) Int. Cl. G09F 7/18; G09F 15/00

(52) U.S. Cl. CPC G09F 7/18; G09F 15/0037; G09F 2007/1852

(57) ABSTRACT

A temporary road sign device includes a panel that has indicia which are applied to the panel. The indicia comprise words and images and numbers corresponding to road signs to visually communicate traffic rules to drivers on a roadway. The panel is comprised of a deformable material thereby facilitating the panel to be rolled up for storage. A coupler is attached to the panel and the coupler releasably engages a front face of a road sign thereby attaching the panel to the road sign. The panel is visible to drivers on the roadway to facilitate the drivers to comply with the traffic rules communicated on the panel.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

### Not Applicable

### BACKGROUND OF THE INVENTION

### (1) Field of the Invention

The disclosure relates to road sign devices and more particularly pertains to a new road sign device for temporarily concealing indicia on a road sign and displaying alternative indicia. The device includes a panel upon which indica are applied which comprise words and images and numbers corresponding to road signage. The device includes a magnetic coupler that is attached to the panel which magnetically engages a road sign thereby retaining the panel on the road sign.

### (2) Description of Related Art Including Information Disclosed Under 37 CFR 1.97 and 1.98

The prior art relates to road sign devices including a variety of sign devices that each at least includes a magnetized panel and a plurality of segments that are magnetically attachable to the magnetized panel for defining a custom message and an emergency sign device that includes a sign with a flap hingedly coupled to the sign with can be positioned to display a first message or a second message. In no instance does the prior art disclose a temporary sign cover that includes a panel with indicia applied to a front surface of the panel and a magnetic coupler attached to the panel which magnetically engages a road sign for mounting the panel to the road sign thereby facilitating the indicia on the panel to replace indicia on the road sign.

### BRIEF SUMMARY OF THE INVENTION

An embodiment of the disclosure meets the needs presented above by generally comprising a panel that has indicia which are applied to the panel. The indicia comprise words and images and numbers corresponding to road signs to visually communicate traffic rules to drivers on a roadway. The panel is comprised of a deformable material thereby facilitating the panel to be rolled up for storage. A coupler is attached to the panel and the coupler releasably engages a front face of a road sign thereby attaching the panel to the road sign. The panel is visible to drivers on the roadway to facilitate the drivers to comply with the traffic rules communicated on the panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a temporary road sign device according to an embodiment of the disclosure.

FIG. 2 is a front view of an embodiment of the disclosure.

FIG. 3 is a cross sectional view taken along line 3-3 of FIG. 2 of an embodiment of the disclosure.

FIG. 4 is a front perspective view of an embodiment of the disclosure showing a panel being rolled up.

FIG. 5 is an exploded in-use view of an embodiment of the disclosure.

FIG. 6 is a front in-use view of an embodiment of the disclosure.

FIG. 7 is a cross sectional view taken along line 7-7 of FIG. 6 of an embodiment of the disclosure.

FIG. 8 is an exploded perspective in-use view of an embodiment of the disclosure.

### DETAILED DESCRIPTION OF THE INVENTION

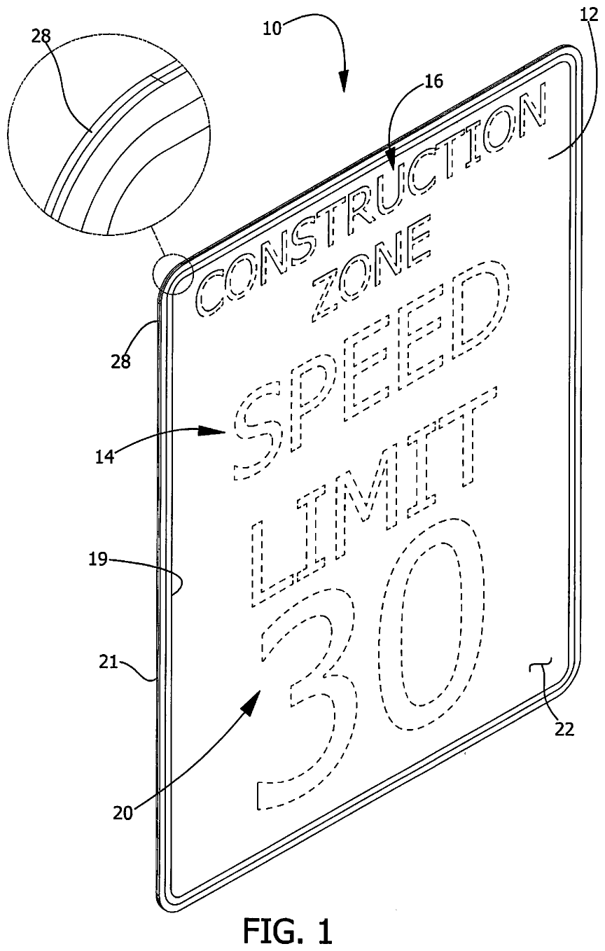

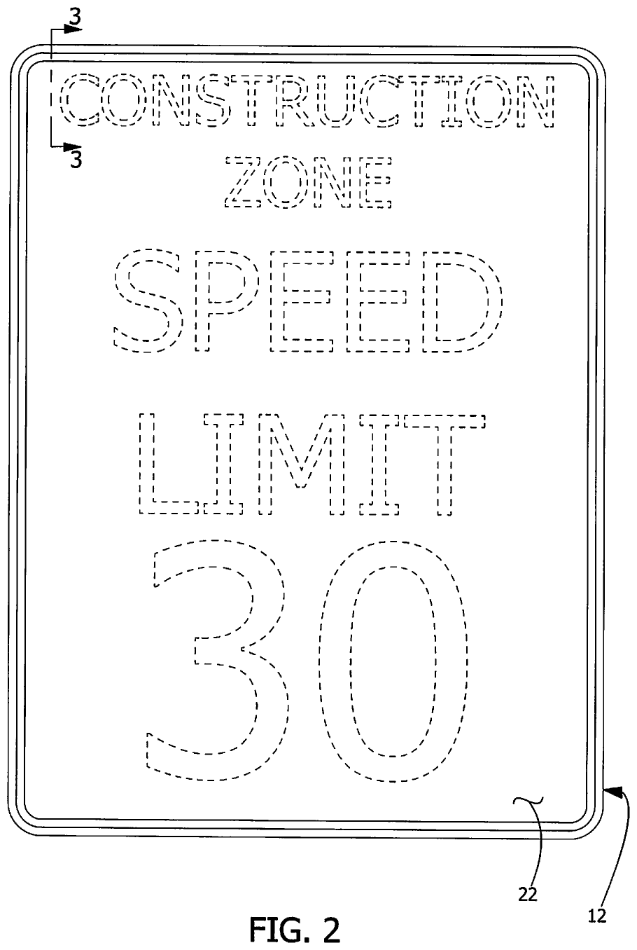

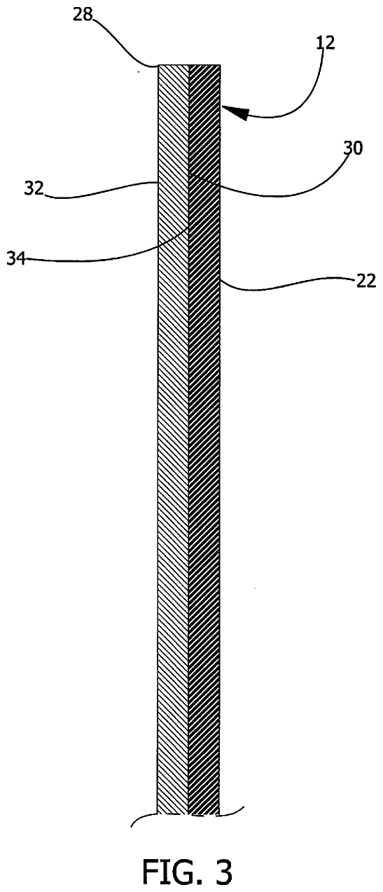

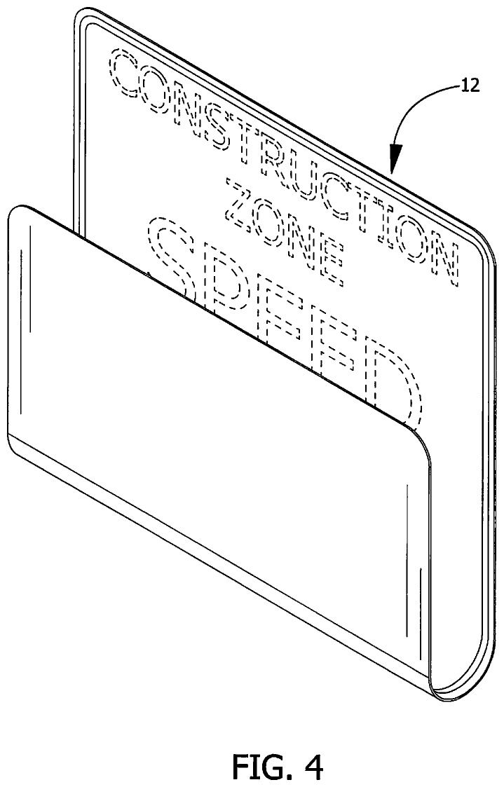

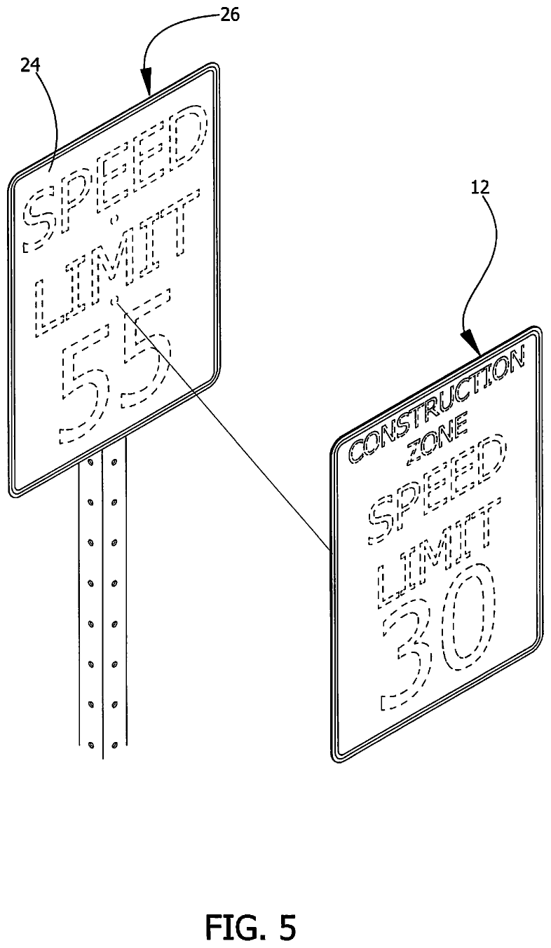

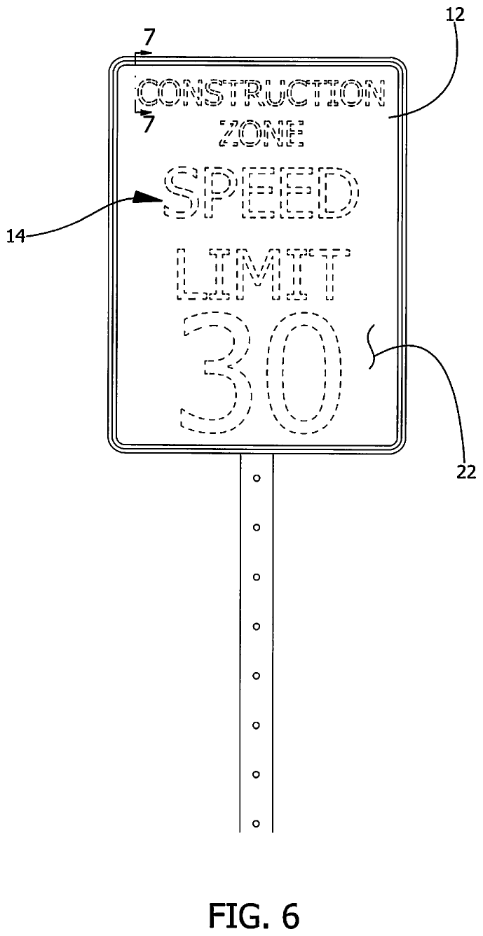

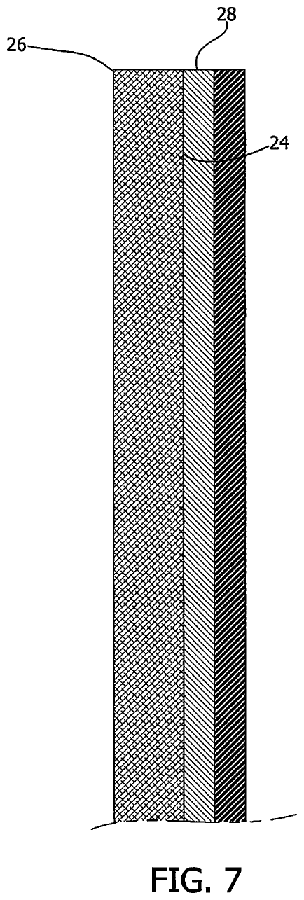

With reference now to the drawings, and in particular to FIGS. 1 through 8 thereof, a new road sign device embodying the principles and concepts of an embodiment of the disclosure and generally designated by the reference numeral 10 will be described.

As best illustrated in FIGS. 1 through 8, the temporary road sign device 10 generally comprises a panel 12 that has indicia 14 which are applied to the panel 12. The indicia 14 comprise words 16 and numbers 20 corresponding to road signage to visually communicate traffic rules to drivers on a roadway. Furthermore, the indicia 14 may include, but not be limited to, a reduced speed limit for a construction zone, a warning for upcoming road work or a detour notice. The panel 12 is comprised of a deformable material, including but not being limited to rubber or silicone, thereby facilitating the panel 12 to be rolled up for storage. Additionally, the indicia 14 may include a border 19 which extends along a perimeter edge 21 of the panel 12.

The indicia 14 are applied to a front surface 22 of the panel 12 and the panel 12 is comprised of an opaque material such that the panel 12 conceals a front face 24 of a road sign 26 when the panel 12 is positioned on the front face 24. In this way the panel 12 inhibits drivers from being able to see the front face 24. Thus, the road sign 26 can be temporarily taken out of service when road construction is being performed, for example, or in any other occasion when the traffic rules displayed on the road sign 26 need to be temporarily concealed. The panel 12 may be structured during the manufacturing process to conform to the shape of various road signs, including but not being limited to, speed limit signs, exit signs, yield signs and caution signs.

A coupler 28 is provided and the coupler 28 is attached to the panel 12. The coupler 28 releasably engages the front face 24 of the road sign 26 thereby attaching the panel 12 to the road sign 26. In this way the panel 12 is visible to drivers on the roadway to facilitate the drivers to comply with the traffic rules communicated on the panel 12. Thus, the road sign 26 does not have to be taken down or covered over as is commonplace during road construction or other types of major roadway projects.

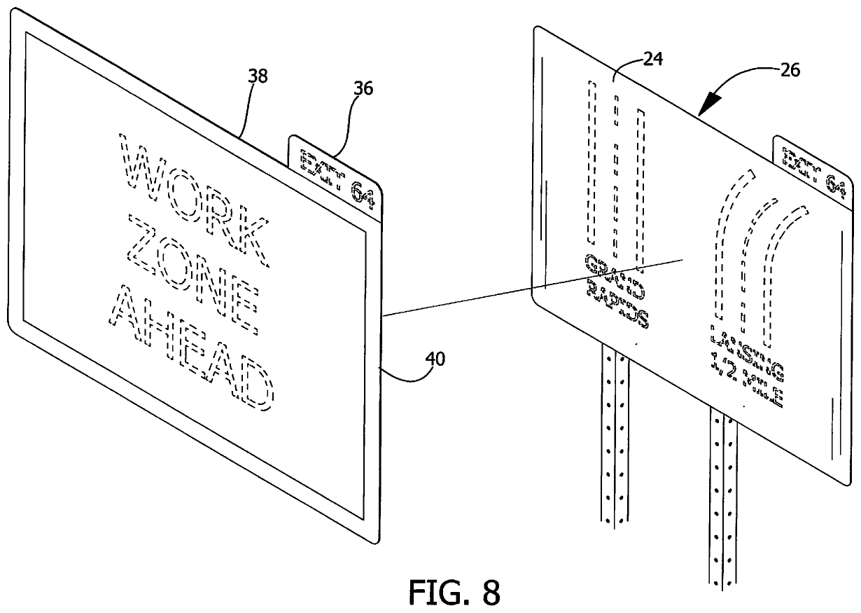

The coupler 28 has a forward surface 30 and a rear surface 32; the forward surface 30 is bonded to a back surface 34 of the panel 12. The forward surface 30 completely covers the back surface 34 and the rear surface 32 abuts the front face 24 of the road sign 26. Additionally, the coupler 28 is comprised of a magnetic material thereby facilitating the coupler 28 to magnetically engage the front face 24 of the road sign 26. In this way the coupler 28 can be easily removed from the road sign 26 yet can still resist being accidentally dislodged by wind or precipitation. As is shown in FIG. 8, a tab 36 may extend upwardly from a top edge 38 of the panel 12 at a point located adjacent to a respective lateral edge 40 of the panel 12. Indicia 14 may be applied to the tab which comprise an exit number for an upcoming exit on the roadway.

In use, the panel 12 is placed on the front face 24 of the road sign 26 such that the coupler 28 magnetically engages the front face 24 to retain the panel 12 on the road sign 26. In this way the indicia 14 on the front face 24 are concealed and the indicia 14 on the front surface 22 of the panel 12 are visible. In this way the indicia 14 on the front face 24 of the panel 12 can communicate traffic rules the drivers while the road sign 26 is temporarily taken out of service for road construction, for example. Furthermore, the road sign 26 does not have to be taken down or covered over as is the current practice of temporarily taking road signs out of service for road construction.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A temporary road sign device for temporarily covering an existing road sign with alternative information, said device comprising:
a panel having indicia being applied to said panel, said indicia comprising words and numbers corresponding to road signs wherein said indicia are configured to visually communicate traffic rules to drivers on a roadway, said panel being comprised of a deformable material thereby facilitating said panel to be rolled up for storage; and
a coupler being attached to said panel, said coupler releasably engaging a front face of a road sign thereby attaching said panel to said road sign wherein said panel is configured to be visible to drivers on the roadway to facilitate the drivers to comply with the traffic rules communicated on said panel.

2. The device according to claim 1, wherein said indicia are applied to a front surface of said panel.

3. The device according to claim 1, wherein said panel is comprised of an opaque material such that said panel conceals said front face of said road sign when said panel is positioned on said front face wherein said panel is configured to inhibit drivers from being able to see said front face.

4. The device according to claim 1, wherein said coupler has a forward surface and a rear surface, said forward surface being bonded to a back surface of said panel having said forward surface completely covering said back surface.

5. The device according to claim 4, wherein said rear surface abuts said front face of said road sign.

6. The device according to claim 1, wherein said coupler is comprised of a magnetic material thereby facilitating said coupler to magnetically engage said front face of said road sign.

7. A temporary road sign device for temporarily covering an existing road sign with alternative information, said device comprising:
a panel having indicia being applied to said panel, said indicia comprising words and numbers corresponding to road signage wherein said indicia are configured to visually communicate traffic rules to drivers on a roadway, said panel being comprised of a deformable material thereby facilitating said panel to be rolled up for storage, said indicia being applied to a front surface of said panel, said panel is comprised of an opaque material such that said panel conceals a front face of a road sign when said panel is positioned on said front face wherein said panel is configured to inhibit drivers from being able to see said front face; and
a coupler being attached to said panel, said coupler releasably engaging a front face of a road sign thereby attaching said panel to said road sign wherein said panel is configured to be visible to drivers on the roadway to facilitate the drivers to comply with the traffic rules communicated on said panel, said coupler having a forward surface and a rear surface, said forward surface being bonded to a back surface of said panel having said forward surface completely covering said back surface, said rear surface abutting said front face of said road sign, said coupler being comprised of a magnetic material thereby facilitating said coupler to magnetically engage said front face of said road sign.

8. A method of temporarily covering a road sign with alternative information, the steps of the method comprising:
printing indica on a front surface of a panel which comprise words and numbers and images that correspond to road signage;
placing said panel on a front face of a road sign such that a coupler on a back surface of said panel magnetically engages said front face of said road sign for retaining said panel on said front face of said road sign, said panel being comprised of an opaque material thereby facilitating said panel to conceal said front face wherein said panel is configured to inhibit drivers from being able to see said front face, said panel being oriented such that said front surface is visible wherein said indica on said front surface are configured to visually communicate traffic rules to the drivers; and
removing said panel from said front face of said road sign when said indicia on said front surface of said panel are no longer required to visually communicate traffic rules wherein said front face of said road sign is configured to be visible to the drivers.
